(19) United States
(12) Patent Application Publication
(10) Pub. No.: US 2018/0300406 A1
(43) Pub. Date: Oct. 18, 2018

(54) FAST SOCIAL NETWORK DATA AGGREGATION AND SUMMATION

(71) Applicant: Veritas FC LLC, Spokane, WA (US)

(72) Inventor: Gavin LaRowe, Spokane, WA (US)

(21) Appl. No.: 15/490,793

(22) Filed: Apr. 18, 2017

(51) Int. Cl. G06F 17/30; G06F 21/60

(52) U.S. Cl. CPC G06F 17/30864; G06F 21/604; G06F 17/30867; G06F 17/30719; G06F 17/30536; G06F 17/30707

(57) ABSTRACT

Fast social network data aggregation and summation provides for retrieving and summarizing one or more web sites relating to a subject person while maintaining confidentiality of subject matter on the one or more web sites. The web sites may be social media accounts and/or personal web sites such as blogs. The web sites are accessed with consent and/or legal authorization and the accesses are logged for audit purposes. The queries are comprised of one or more topics such that the retrieved data from the queries may be clustered into concept data sets around those topics. The concept data sets may then be aggregated and distributed, and subjected to statistical analysis, filtering, and reporting.

### BACKGROUND

Microblogging sites, such as Facebook™ and Twitter™ in effect collect postings and responses from individuals reviewing the site. Often the postings are personal in nature, and a site operator, including potentially a site owner, will select a set of trusted users, known as “friends”, to help direct the sharing of postings and the receipt of responses. In effect, the connections with friends comprise a “social network” among the web sites, and by extension among the site owners.

A social network therefore creates a repository of information specific to a person that is generally not available via other means. Furthermore, this set of information may become statistically significant. Over time, the site operators may accrue so much content, that it is difficult or impractical to move the content to a different site. This in turn encourages the addition of more information. This virtual cycle makes it likely that the site will have a critical mass of data in the account to predict a person's likely behavior.

Notwithstanding the efforts of social network vendors, individuals may keep different social network accounts, often with different social network vendors. Different accounts may be maintained not only for technical reasons, such as different formats between Facebook™ and Twitter™, but also because the site operators may wish to give different impressions for different contexts. For example, a family site would have different tone and content than a professional site or a hobby site. The result is that different accounts can be cross referenced against each other and an event more accurate and reliable predictive model of the user's behavior made.

However, because of the sheer volume of data, the very basis of the reliability and accuracy of using social data, processing social network data lends itself to automation. The more data available, the more reliable and accurate a predictive behavior model of the site operator is likely to be; but conversely, the more difficult it is to make the model quickly and accurately.

### BRIEF DESCRIPTION OF THE DRAWINGS

The Detailed Description is set forth with reference to the accompanying figures.

FIG. 1 is context diagram for fast social data aggregation and summation.

FIG. 2 is a diagram showing the hardware, software and network environment for fast social data aggregation and summation.

FIG. 3 is a block diagram for fast social data aggregation and summation.

FIG. 4 is a flow chart to consolidate social network data.

FIG. 5 is a flow chart to query social network data.

FIG. 6 is a flow chart to aggregate and summarize social network data.

### DETAILED DESCRIPTION

### Overview of Fast Social Network Data Aggregation and Summation

Fast social network data aggregation and summation are described herein. Specifically, data about a subject person is aggregated, and is subsequently retrieved from one or more personal sites, including but not limited to social network sites of or about the subject person. Then the aggregated data is summarized. The aggregated data is then presented to a requesting user to emphasize topics of interest as specified by the requesting user. The aggregated data may be presented with additional meta-information, such as suggested topics. In this way, a requesting user may quickly obtain a quick estimation of the subject person's likely behavior in at least the topics of interest. Alternatively, a requesting user may determine that there is insufficient information in the aggregated data, to estimate the subject person's likely behavior.

There are several issue involved in the foregoing. One issue is privacy. Social network and other data about a subject person are typically subject to access control. Even on public social networks, a subject person generally has the option to limit access only to trusted users designated as “friends.” In other cases, a subject person may limit access only to himself or herself. Access to data may be gained by obtaining consent from the subject person.

Another issue is the wide variance of ways to access data about a subject person. Common social networks such as Facebook™ and Twitter™ typically provide application programming interfaces (APIs) to provide third parties programmatic access to their sites. Nonetheless, APIs are subject to change. Programmatic access to data may be managed via a common programmatic layer which features plug-ins to interface with different social networks and sources of data. As APIs change or as new sources of data are added, a plug-in corresponding to the data source is all that need be programmed. All programmatic access to data in order to perform aggregation and summation functionality will be via the common programmatic layer.

Another issue is providing locality of data. Upon aggregating data from one or more data sources, the aggregated and summarized data may be stored as a single local dataset thereby creating a snapshot. This snapshot may be stored proximate to a user for review. In this way, data need not be called and recalled repeatedly directly from the social network and other data sources, thereby causing slowdown. Rather the snapshot may be access from a proximate local network, or even locally on the user's machine.

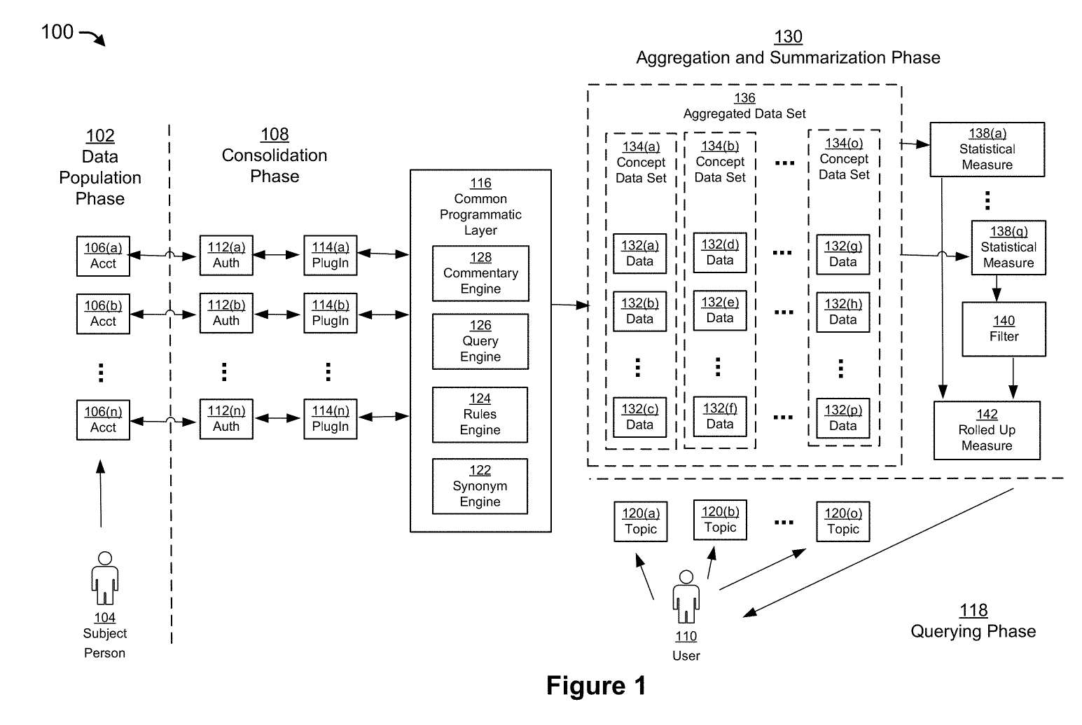

FIG. 1 is a framework diagram 100 comprised of stages in aggregating and summarizing social network and other data about a subject person.

In a Data Population Phase 102, a subject person 104 creates one or more social network accounts and/or personal web sites 106a thru 106n, and populates the accounts with data. The social network and/or personal web sites 106a thru 106n may be accessed also by trusted users known as “friends” who also may contribute content.

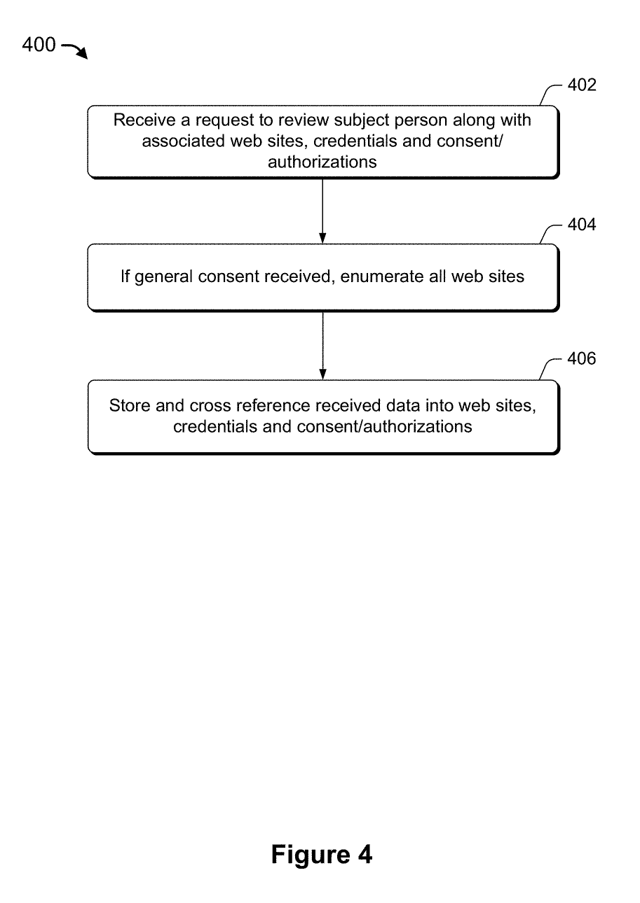

In a Consolidation Phase 108, a user 110 requests privileges and/or consent from the subject person 104 to access the social network accounts and/or personal web sites 106a thru 106n. The user may then obtain corresponding authentication credentials 112a thru 112n to the social network accounts and/or personal web sites. The user 110 will then identify plug-ins corresponding to the social network accounts and/or personal web sites 114a thru 114n and connect to a common programmatic layer 116. Upon the establishment of data access to the social network accounts and/or personal web sites 106a thru 106n, via the verification of the authentication credentials 112a thru 112n, the Consolidation Phase 108 is complete. At this point, the user 110 may start retrieving data via the common programmatic layer 116. The Consolidation Phase 108 is described in more detail with respect to FIG. 4.

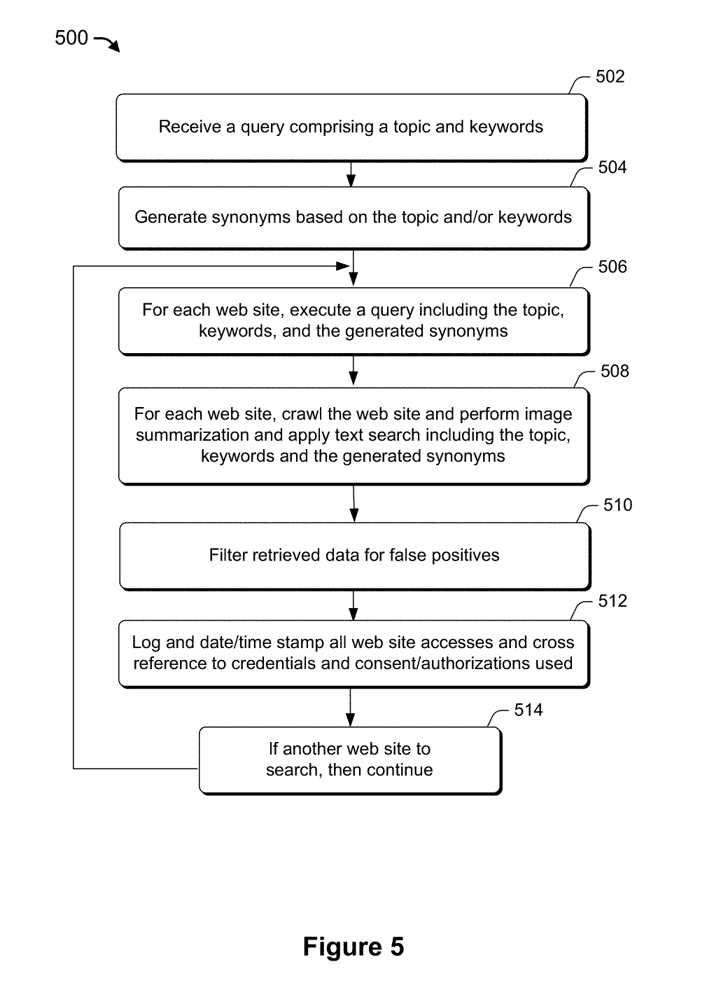

In a Querying Phase 118, the user 110 specifies topics 120a thru 102o, via specifying one or more concepts per topic. A concept may be specified by a keyword. A synonym engine 122 may be used to retrieve keywords that are synonyms. A rules engine 124 may specify further restrictions as to when a keyword applies to a concept and when it doesn't. For example, an n-gram rule may only allow specific words to be used as keywords for a concept when the word performs as a subject in a phrase. By way of another example, a fuzzy logic rule may allow specific words to be used as keywords for a concept following a statistical curve. Upon specification of the concepts, the concepts are submitted to a query engine 126 which then retrieves data from each of the data sources comprising the social network accounts and/or personal web sites 106a thru 106n. Note that data queried may include not only the postings of a subject person, but also profile data of a subject person. Furthermore, notes entered by the user 110 in a commentary engine 128 may also be accessed. The Querying Phase 118 is described in more detail with respect to FIG. 5.

In an Aggregation and Summarization Phase 130, the query engine 126 returns a plurality of data sets 132a thru 132p, each corresponding to a data source 106a thru 106n and a topic 120a thru 120o. Although the data sets 132a thru 132p may have different metadata, their respective metadata corresponding to the API of their respective data source 106a thru 106n, data sets from different data sources may be combined by their respective concepts. Once the datasets 132a thru 132p are combined into concept datasets 134a thru 134o, each data set corresponding to a topic 102a thru 120o, the datasets may be combined according to media type. For example, images may be stored proximate to other images, videos may be stored proximate to other video, and comments may be stored proximate to other comments. In this way, media type may be used to create a behavioral model. At this stage, the data is sorted by concept and media type, and is thereby aggregated in an aggregated data set 136. This aggregated data set 136 may be stored on the user's 110 local network or even the user's 110 local computer.

While the aggregated data set 136 may be limited to the concepts specified during the Querying Phase 118, it potentially is still be a large amount of data. Accordingly, the aggregated data is to be summarized. Specifically, the aggregated data set 136 is to be subjected to statistical measures 138a thru 138q corresponding to some subset of topics 102a thru 120o, subdivided by media type, or other subdivisions. For example, a topic might be, “skydiving” and counts of images of the subject person 104 skydiving, of text blog postings by the subject person 104, and by comments to those postings by the subject person's friends.

The statistical measures 138a thru 138q may be subject to a filter 140. For example the count of images of the subject person 104 skydiving could be limited to counts of photosets. In this way, a single skydiving session with one hundred pictures would be counted just once as opposed to one hundred different skydiving sessions each with only one picture. Other examples of a filter 140 might be to count only positive comments by the subject person's friends as opposed to negative comments.

The statistical measures 138a thru 138q themselves may be subjected to further summarization by applying a rolled up measure 142 which is a formula using the statistical measures 138a thru 138o as inputs. In the previous skydiving example, the sum of the skydiving image count, of postings by the subject person 104, and of comments by friends to those postings may be calculated, and presented as an indication of the subject person's propensity for skydiving. More complex formulas may be used as well, such as weighted averages, normalized scores, and the like. In this way, a single number could be used to summarize an indication of the propensity for a behavior without presenting the underlying content from the personal web sites 106a thru 106n.

### Exemplary Hardware, Software and Communications Environment

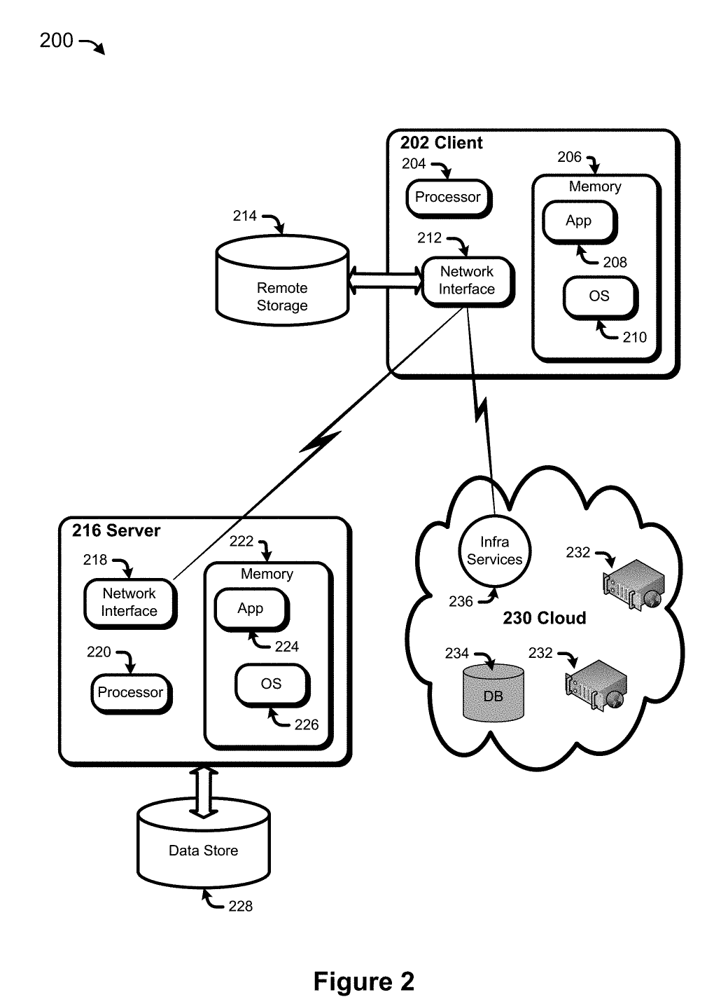

FIG. 2 is a diagram 200 of an exemplary hardware, software and communications environment for fast social network data aggregation and summation.

Requests to perform fast social network data aggregation infrastructure may be performed from a client machine 202. A client machine 202 may be any device with a processor 204, memory, 206 and a network interface 208 sufficient to connect to a cloud server, either directly or via the Internet. Typically there will be an operating system 210 and one or more applications 212 resident in the memory 206. Typical configurations are a central processing unit, RAM, and Wi-Fi or Ethernet connectivity. The memory 206 will be computer-readable media and/or will have access to other computer-readable media, and will run a client application 212 comprised of computer executable code resident in the memory and/or other computer-readable media. The client 202 may have access to remote storage 214 such as Network Aware Storage (NAS) 216 on the local network.

Similarly a server 216 or cloud services 218 may be a device with a processor 220, memory 222, and a network interface 224 sufficient to connect to a client machine either directly or via the Internet and to other web sites on the Internet. As with a client machine, typically there will be an operating system. Typical configurations are a central processing unit, RAM, and Wi-Fi or Ethernet connectivity. The memory will be computer-readable media and/or will have access to other computer-readable media, and will run an application 226 and operating system 228 comprised of computer executable code resident in the memory and/or other computer-readable media. The server may access have a database or datastore 230 locally or on its local network.

A cloud server 232 may generally run a virtualization environment 234 that may create virtual machines. In each virtual machine, there may be an operating system, or system level environment. Each virtual machine may spawn processes, each of which may spawn threads. An execution environment such as a Java Virtual Machine, or .NET runtime may execute in a virtual machine and manage processes and threads. Servers 232 may also come in the form of database servers 236 as well.

Note that computer-readable media includes, at least, two types of computer-readable media, namely computer storage media and communications media. Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD), Blu-Ray, or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transmission mechanism. As defined herein, computer storage media does not include communication media.

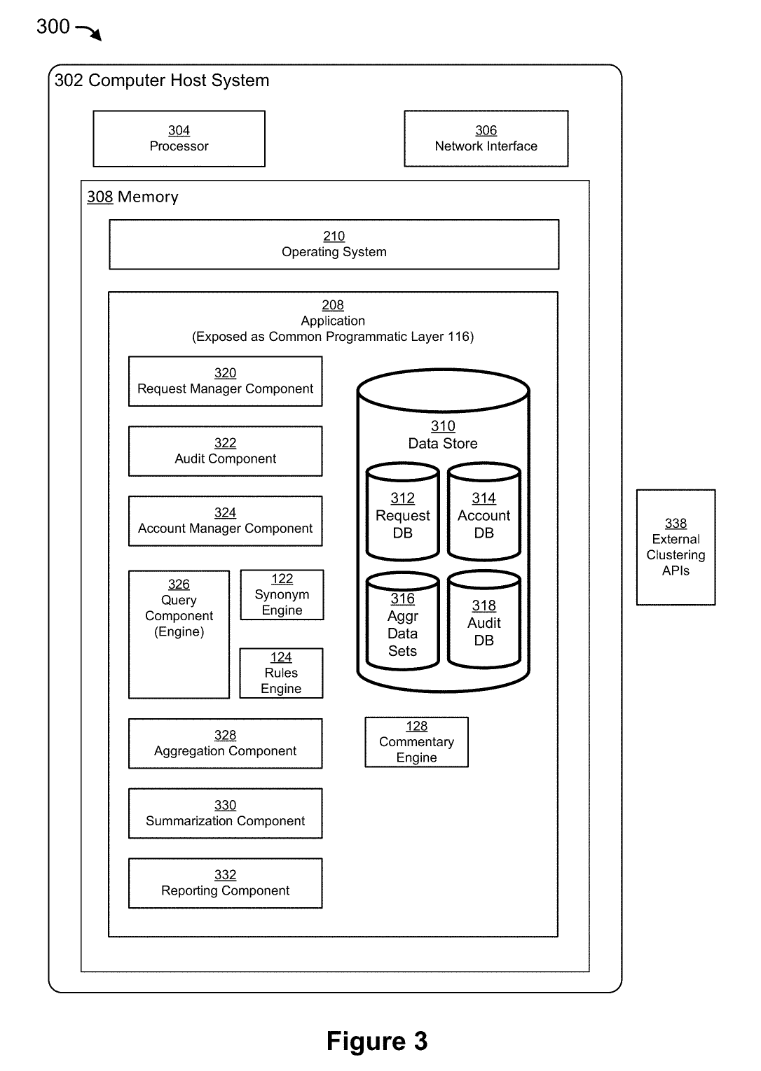

FIG. 3 is an illustration 300 of a configuration for an exemplary system to support fast social network data aggregation and summation.

The configuration comprises a computer host system 302 with a processor 304, and a network interface 306. The memory 308 may be RAM and the network interface 306 may be a network interface card sufficient to access the Internet. The computer host system 302 may be hosted on a virtual machine in a cloud environment. The computer host system 302 has access to a data store 310 which stores a request database 312, an account database 314, a database of aggregated data sets 316, and an audit database 318.

In the memory 308 is an operating system 210 and a set of application components 208 comprising the application. The application may expose itself as an Application Programming Interface (API) corresponding to the Common Programmatic Layer 116 as shown in FIG. 1. The application components may include a software request manager component 320, software audit component 322, software account manager component 324, software query component 326, software aggregation component 328, a software summarization component 330, a software reporting component 332 and other support components such as synonym engine 122, rules engine 124, and commentary engine 128.

The software request manager component 320 manages incoming requests to review web sites of a subject person. It takes incoming requests, identifies web sites, their respective access credentials, and documents the degree of consent provided by the subject person to access the identified web sites, or other basis of authorization. The software request manager component is 320 stores request information in the request database 312.

Due to the sensitivity of the account information, the software request manager is communicatively coupled to a software audit component 322. The software audit component 322 tracks all accesses to web sites including logins and queries and stores records of those accesses within an audit database 318. In this way, there is an auditable records showing that all accesses were within the degree of consent provided by the subject person, or were otherwise authorized.

The web sites within a request are associated with credentials and consents. The software account manager component 324 stores the respective requests associated with credentials and consents within account database 314. The account database stores consents, accounts, and credentials in different cross referenced tables. In this way, a consent can cover more than one account. For example, a subject person may provide a blanket consent that covers all accesses. By way of another example, if the accesses are supported by a single search warrant, only that single source of authorization need be tracked. In other cases the subject person will provide a single credential that may cover multiple web sites. For example, a Facebook™ credential may be used to access not only Facebook™ but also sites that use Facebook™ authentication credentials.

Software query component 326 is a query engine that accesses the accounts via the software account manager component 324. It receives a query, typically in the form of keywords covering particular topics, and may generate synonyms for those concepts, potentially using synonym engine 122. It then retrieves text and/or text representations of items on the web sites based on the query and metadata such as media type and date posted. The retrieval may be based on rules as stored and/or processed by rules engine 124. The retrieval may be based on a calculated similarity score. The retrieved data is also associated with access data including the web site, the date of the retrieval, and the credential used. The access data is subsequently stored in the audit database 314 by the software audit component 322.

The software query component 326 may also apply third party tone content APIs 336 to determine tone and context of web site content. For example, vendors such as Receptiviti™ and Alchemy™ that provide APIs to indicate personal and emotional tone in text. In this way, the software query component 326 may apply contextual metadata to determine whether content is positive, negative, ironic, unserious, malicious or otherwise in a context apposite to a literal interpretation.

The software query component 326 provides create, update, and delete data capabilities in addition to the retrieval capabilities as described above. The software query component 326 may be used to perform extract, transform and load (ETL) functions to load the data store 310. During load time, user generated comment may be added to the data loaded into data store 310 via commentary engine 128. Specifically, the commentary engine may receive user generated content, create a record in data store 310 of the user generated content, and store an association, relational, pointer (memory location) or otherwise, with a data set retrieved by a query.

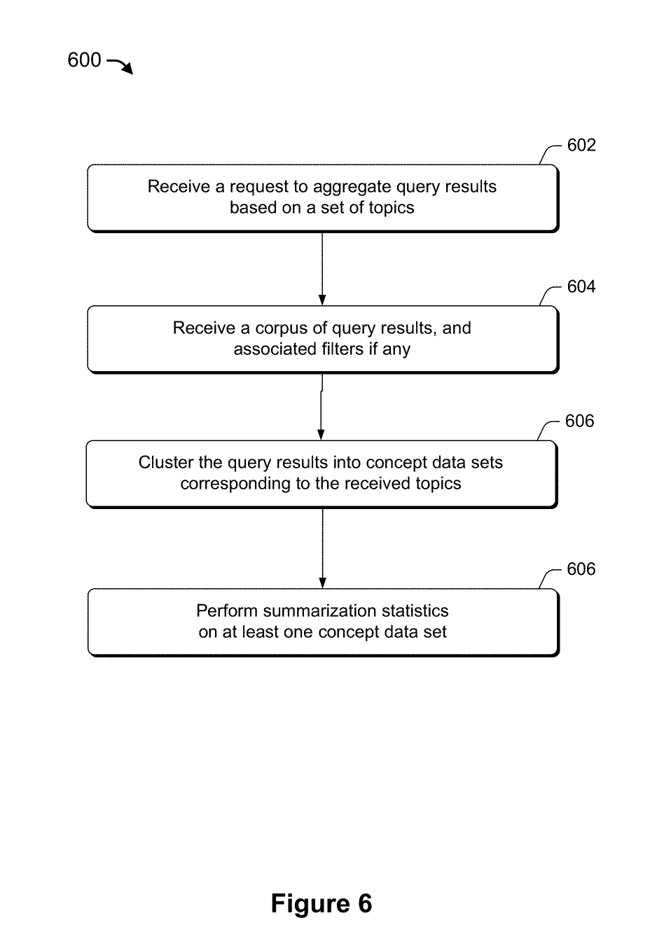

Data retrieved by the software query component 328 will generally be relevant to its respective query. However, the query may have false positives. Furthermore, data retrieved from different queries may be related. Accordingly, the software aggregation component 328 make take the corpus of data retrieved by the software query component 326 from one or more queries and organize the data into conceptual clusters. The software aggregation component 328 may make use of external clustering APIs 338. The operation of the software aggregation component is discussed in further detail with respect to FIG. 6.

Software summarization component 330 applies statistical analysis to the conceptual clusters generated by the software aggregation component 328. Simple statistical analysis may include simple counts, maxima, minima, and averages. Statistics on individual conceptual clusters may themselves be applied to other statistical formula. In this way, the data aggregated by the software aggregation component 328 may be reduced to a few numbers. The resulting statistics may be presented to a user via software reporting component 332. The software reporting component 332, may make use of charts and graphs to thereby present the statistics in a graphical user interface.

### Consolidation of Personal and Social Network Data

FIG. 4 is a flow chart illustrating consolidation of personal and social network data. Specifically, access to a subject person's personal and social network data is to be obtained and metadata associated with the degree of access obtained is to be stored for audit purposes.

In block 402, a software request manager component 318 receives a request to review a particular subject person and stores it in the request database 310. The request includes an identity of the subject person, a list of reported web sites to access, the credentials to access the respective sites, and the degree of consent or authorization. The software request manager component 318 stores the request in the request database 310 and via the software account manager component 320, stores list of web sites, credentials, and consent/authorizations in the account database 312.

Consent and authorization may be of various types and from various sources. In some cases, the data is public. In other cases, the subject person provides credentials. In yet other cases the subject person allows access via a social network's “friend” mechanism. Authorization may be provided by a written statement, or click through agreement by the subject person. Authorization need not be from the subject person. For example, in the case of law enforcement, a search warrant on electronic material may be obtained from a court.

If the request includes a blanket consent, that is a general consent or authorization to access all web sites, then in block 404, the software account manager 320 will enumerate a list of other web sites that may be access using the credentials provided. Examples are using a Facebook™ set of credentials to access third party sites that delegate identity and logon services to Facebook™. An example of a general consent or authorization is a search warrant issued by a court.

In block 406, the accounts are then consolidated into three tables: (1) web site, (2) credentials, and (3) consent. The tables may be cross referenced thus the cardinality of the records need not be one to one. For example, one set of credentials may map to multiple web sites. A consent may cover more than web site as well. Records in the consent table may contain links to authorization documents such as a signed consent statement by the subject person or a search warrant from a court. In other cases, such as the web site being accessible by the general public, no link would be needed. At this point, the web site accesses are consolidated and ready for querying.

### Querying Consolidated Personal and Social Network Data

FIG. 5 is a flow chart illustrating querying consolidated of personal social network data.

In block 502, the software query component 324 receives a query comprised of a topic and one or more keywords. While the query could cover multiple topics, the software query component 324 tracks topics and keywords used to retrieve data for use in subsequent aggregation operations.

In block 504, the software query component 324 generates synonyms corresponding to the received topic and/or keywords. In this way the query will not exclude potential positive results. False positives will be filtered out via the subsequent aggregation operations.

The query is executed in block 506 on a site by site basis. Specifically, the expanded topic and keyword terms from block 504 are applied to a general keyword search on at least a portion of the web sites associated by the software account manager component 320 for a particular request on a subject person.

In block 508, for each web site, a spider or bot may crawl the site, by traversing all the links in the site and performing a text based search. In cases where media such as images and video are encountered, image summarization software may be applied to obtain a text summary, and the text based search then is applied to that text summary. Alternatively, where the web site provides active accessibility alternative text, the text based search may then be applied to that text summary. Where a match exists, a text summary, a reference, data time stamp, web identifier and a reference to the query terms are stored in the database of aggregated data sets 326. The raw retrieved data will later be aggregated into an aggregated data set. A match may be determined by applying a similarity score to the text summary.

The above approach describes converting multimedia data into textual data and then applying a query. However, some forms of queries rely on lexical analysis that assume a grammar Since some text summaries may not comply with a grammar, let alone be structured in a sentence, another variation may be to perform a content based queries on multimedia, such as those based on machine learning, and to immediately determine whether the multimedia data relates to a topic in a query.

In block 510 the retrieved data may be filtered. One form of a filter is to apply a third party tone API 332 may be applied to a retrieved object to identify tone. As stated above, many times web postings are added for humor, irony, and other non-literal contexts. To reduce the likelihood that non-literal postings would introduce errors in subsequent aggregation and summarization operations, a third party tone API 332 such as Receptiviti™ and/or Alchemy™ may be applied and the results stored as metadata with the text summary.

In block 512, the software audit component 322 logs all web accesses storing the identity of the web site, the corresponding credential and consent/authorization, and a date/time stamp of the access. The software audit component 322 may also associate the request on a subject person, topics queried, keywords, user content generated, and/or synonyms generated. The software audit component 322 may generate an identifier that may be used by retrieved data to identify the query the retrieved data came from.

In block 514, if there are no more web sites as enumerated by the account list to be searched, then operation is complete. Additional queries may then be performed and the combined raw retrieved data may then be aggregated.

### Aggregating and Summarizing Consolidated Personal and Social Network Data

FIG. 6 is a flow chart illustrating aggregating and summarizing consolidated personal and social network data.

In block 602, a request to aggregate data retrieved from one or more queries for a particular subject person is received. The request may include a filter which specifies raw retrieved records not to be considered for aggregation. The request also includes a specification of statistics to be returned upon completion.

In block 604, a corpus of raw retrieved data is collected according to the request from block 602 and filters if any. Specifically, in the database of aggregated data sets 314, data stored during the query phase is retrieved subject to the filter, and stored into a corpus file. Each data record may be associated with a weight indicating whether it is more credible. For example, blog posts by the subject person may be weighted more than comments by friends.

In block 606, the weighted corpus file is sent to a third party knowledge analytics platform such as PushGraph™. The corpus is then scanned, topics identified by the knowledge analytics platform, with data clustered around those topics. The clustered data not constitutes and aggregated data set and is accordingly stored in the aggregated data sets database 314.

There are a number of known clustering algorithms that may take a corpus of text and cluster the text around particular topics. The clustering algorithms generally parse textual data, and based on lexical analysis perform similarity scores on subsets of the text to the topics. Based on a predetermined threshold value or threshold function, text is deemed to be part of a cluster. Known techniques include hierarchical clustering and K-Means clustering.

Upon receiving an indication that the knowledge analytics is complete, in block 608, the aggregated data set is summarized. Specifically, the statistics specified in the request are applied to the aggregated dataset. As described above, statistical operation may be applied to different topic clusters, different media types, and other subdivisions of the aggregated data. Also statistical operations may be applied to the resulting statistical calculations on the data subdivisions.

Upon completion of summarization, a report is generated by the software reporting component 330. The software reporting component 330 may include graphical representations of the returned statistics, confidence/error calculations and the like. For soft copy reports, the software reporting component 330 may optionally password protect/encrypt the resulting report. Upon receipt of a request, and potentially confirmation of payment, the report may then be sent to the requesting party.

### Behavioral Analysis of Fast Social Network Data Aggregation and Summation

One use case of fast social network data aggregation and summation is in behavioral analysis. Specifically, a user may wish to determine whether a subject person is likely to have some behavioral characteristics. This may be performed by calculating a risk that a person will perform one or more behaviors.

One way to calculate risk is to identify whether the subject person had engaged in a particular behavior in the past. To minimize error, the query, aggregation and summarization process is to minimize false positives and to analyze whether the frequency and timing of behavior indicate a present risk. Accordingly, queries using fast social network data aggregation and summarization may engage: (1) querying web sites to determine instances of a behavior, (2) times and locations, and (3) confidence.

Regarding the querying of web sites, the queries use keywords and synonyms to determine whether there is a candidate instance of behavior. For example, a user seeking evidence that a subject person had an alcohol drinking problem, might search for alcohol, but the synonym engine may search for beer, cider and whiskey.

Filters may be applied to ensure that the candidate instances are indeed evidence. For example, a tone API may be used to determine whether a post was in jest rather than serious. Alternatively, confidence statistical weights may be applied to data sets. For example, a posting by the subject person may be weighted higher than that of a friend's comment.

User generated content may be applied to provide additional context. For example, a subject person may have thousands of entries about wine, but the user performing the queries may make an annotation that the subject person is a vintner or winery owner by profession. Thus by adding user generated content, post processing may weight certain data sets lower, or even eliminate those entries.

Post processing of a query may come in the form of a rules engine. For example, if a profile may be added for a subject person, a rule that data sets mentioning wine are eliminated if the person is a vintner by trade may automatically filter out those data sets as false positives. As a rules engine is populated, the user can refined the specific events deemed to be relevant to determining behaviors. By way of example, a search for alcohol, may be modified into a search for drunken while intoxicated (DUI), drunk and disorderly legal charges, postings about alcohol addiction self help groups.

A second way to calculate risk is to perform root cause analysis, for example using Bayesian analysis. A user may eventually collect enough rules and data (or obtain from a third party source), as to what events are indicators for a particular behavior. In Bayesian analysis, these indicators are placed in a tree data structure, with the indicators stored as child nodes and the behavior stored as a parent node. Indicators themselves will have their own indicators which in turn are stored as child nodes respectively.

Probabilities are then associated as to the confidence as to whether an event in a child node is an indicator for the event in the parent node. These probabilities may be generated by performing machine learning on a set of subject persons with known outcomes. Those probabilities may be refined as data on indicators are obtained from the rules engine.

Once the tree is populated, the queries search not only for the behavior in question, but also for the indicators as set forth in the tree. Thus, even if a behavior is either not posted or is disguised or otherwise concealed by a subject person, analyzing indicators using Bayesian analysis can still generated a likelihood that a subject person might engage in a particular behavior.

Once the risk that a subject person may engage in particular behaviors is calculated, one may in turn roll up the risk for a single decision. For example, if a user wished to determine whether to make a car loan, that user might consider likelihood of bankruptcy, likelihood of unemployment, likelihood of adverse health events, and the like as inputs into a single calculation as to whether the subject person would default on a loan. By way of another example, a car rental company might also consider whether a subject person had engaged in drunken while intoxicated, had a recent history of car accidents, and had a history of late payments, as inputs into a single calculation as to whether to rent a car. In this way, statistical and machine learning techniques may be applied to the clusters of data in order to perform behavioral analysis.

The foregoing discussion of behavioral analysis has been in the context of a single subject person. Note that behavioral analysis may be applied to groups of people as well. One context is that of directed advertising, where advertisements are directed to individuals likely to act on those advertisements. Fast social network data aggregation and summation may be used to determine a set of advertisements of interest to the subject person. Specifically, advertisements are selected on various indicators. Some indicators are general, such as the person is likely to use a particular computer or cellular platform, and has a history of acting on internet advertising. Other indicators are specific to the subject person, such as the subject person is interested in Japanese sports cars, and therefore would be receptive to advertisements related to this field.

While advertising may be directed to an individual, fast social network data aggregation and summation may be directed to groups as well. One way is to select a group of unrelated individuals, and perform batch processing for interests on all groups. Interests and indicators may be placed into a histogram, and advertising may be selected based on the most common interests and indicators across the individuals. In some cases, analysis may be performed to determine which common interests and indicators are statistically significant, and to direct advertising only to those common interests and indicators.

Another way to apply fast social network data aggregation and summation to a group, is to perform a series of queries not just on an individual subject person, but also to a group. For example, some groups are of closely affiliated individuals, and have a common social network and internet presence. For example, several subject individuals may be a member of a particular organization. Accordingly, queries may collect data sets based on the organization. Note that where analysis is performed only against one individual, rules may be made to determine if membership or employment with an organization is indicative of a likely behavior. For certain groups where affiliation with a group is indicative of a likely behavior, the group may be analyzed together in a single computing batch.

One way to test whether affiliation with a particular organization is indicative of likelihood of a behavior, is to measure the likelihood of a group as a batch, and compare the results against the aggregated likelihood of individuals comprising the group, individually measured. If the results are similar, then there is a high correlation that affiliation with a group is indicative of the likelihood of a behavior. In this way, fast social network data aggregation and summation may be applied to groups and to the general use case of marketing and advertising.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of performing queries, comprising:
receiving a query pertaining to a subject person, including at least one topic, at least one keyword;
receiving a set of web sites to query, a set of credentials for at least some of the web sites in the set of web sites, and at least one consent to access at least some of the web sites;
for each web site in the set of web sites, determining whether consent is provided to access the respective web site,
if it is determined that consent is provided, accessing the respective web site by performing the query based at least on the at received at least one topic and the received at least one keyword,
storing the result of the query as a dataset; and
storing a log of the access of the web site.

2. The method of claim 1, wherein the consent is a blanket consent that provides consent to all web sites pertaining to the subject person.

3. The method of claim 2, wherein the consent is provided via a legal search warrant.

4. The method of claim 1, wherein the performing the query comprises:
crawling the respective web site to identify at least one multimedia image;
generating a textual image summarization on the at least one multimedia image; and
applying the query to the generated textual image summarization.

5. The method of claim 1, further comprising:
receiving user generated content pertaining to a respective retrieved data set; and
storing the received user generated content and associating the stored user generated content with the respective retrieved data set.

6. The method of claim 1, further comprising generating a synonym based at least on one received topic or on one received keyword; and wherein performing the query is based at least on the generated synonym.

7. The method of claim 1, wherein the performing the query includes selecting a received topic or a received keyword or both, is based on the application of a rule and a rules engine.

8. The method of claim 1, further comprising: filtering at least one retrieved data set.

9. The method of claim 1, wherein the filtering is via the application of a tone API.

10. A method to aggregate and summarize data sets comprising:
receiving a set of topics and a set of data sets to aggregate and summarize;
clustering the received data sets around at least some topics from the received set of topics in to concept data sets; and
calculating at least one statistic by applying at least one statistical function on at least one of the concept data sets.

11. The method of claim 10, wherein the clustering is performed using at least one of the following:
Hierarchical clustering; and
K-means clustering.

12. The method of claim 10, wherein the calculating is a calculating of a plurality of statistics, and wherein at least one calculated statistic is based on applying at least one statistical function on a previously calculated statistic

13. The method of claim 12, wherein the calculated statistic based on a previously calculated statistic is a rollup calculation to summarize substantially all of a concept data set.

14. The method of claim 10, wherein the concept data set is filtered for false positives prior to the calculating at least one statistic.

15. The method of claim 10, wherein at least one received data set includes user generated content by a party performing a query to retrieve the at least one received data set.

16. A system to perform data aggregation and summarization, comprising:
a processor;
a computer readable memory, communicatively coupled to the processor;
a data store resident in the memory storing at least web site data, credential data, and consent data;
a request manager component resident in the memory configured to receive queries comprising at least one topic, at least one keyword, a set of web sites, a set of credentials, and at least one consent to access a web site;
an account manager component resident in the memory, configured to store received sets of web sites, sets of credentials, received consents, and their interrelationships;
a query component resident in the memory, configured to perform received queries on the received sets of web sites; and
an audit component resident in the memory, configured to log an access of a web site with a credential.

17. The system of claim 16, further comprising a synonym engine resident in the memory, configured to generate synonyms from received topics and received keywords.

18. The system of claim 16, further comprising a rules engine resident in the memory, configured to determine whether a topic or keywords is to used by the query component in performing a query.

19. The system of claim 16, further comprising a commentary engine resident in the memory, configured to receive user generated content, and to associate user generated content with data sets resulting from queries performed by the query component.

20. The system of claim 16, further comprising:
an aggregation component resident in the memory, configured to cluster data sets resulting from queries performed by the query component around at least one topic into concept data sets, and
a summarization component resident in the memory, configured to perform at least one statistical function on at least one concept data set.
